(19) United States
(12) Patent Application Publication
(10) Pub. No.: US 2003/0072987 A1
(43) Pub. Date: Apr. 17, 2003

(54) Conduit system for fluids and gases in a fuel cell

(75) Inventors: Hans Ries, Marl (DE); Guido Schmitz, Duelmen (DE); Harald Haeger, Reclinghausen (DE); Olivier Farges, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/269,052

(22) Filed: Oct. 11, 2002

(30) Foreign Application Priority Data
Oct. 11, 2001 (DE) 10150258.3

(51) Int. Cl. H01M 8/02; B60L 11/18

(52) U.S. Cl. 429/34; 180/65.3

(57) ABSTRACT

An element of a conduit system of a fuel cell, wherein the part which is in contact with the conveyed medium is composed of a polyester molding composition, can be manufactured at low cost, has a good barrier action with respect to the conveyed medium and releases very substantially no components which poison or polarize the catalyst.

### BACKGROUND OF THE INVENTION

1. Field of the Invention

The present invention relates to an element of a conduit system of a fuel cell, where the system comes into contact with fluids and with gases.

2. Background of the Invention

The increased stringency of environmental legislation is forcing manufacturers of motor vehicles to consider new drive systems, since it is specifically toward NOₓ emissions that legislators are directing their attention. Fuel cells provide a possible alternate drive system.

A wide variety of embodiments of fuel cells have been known for a long time. A feature common to these is that a fuel is fed to the anode space and air or oxygen is fed to the cathode space. These reactants are reacted catalytically at the electrodes. The fuels used may comprise hydrogen, methanol, glycol, methane, butane, higher hydrocarbons, etc., but only the first of these achieves current densities sufficiently high to permit the use of a fuel cell operating at about room temperature for driving a motor vehicle. The other fuels can only be reacted satisfactorily in a medium- or high-temperature fuel cell, and this is primarily attractive for stationary systems. In the case, therefore, of a motor vehicle which has an electrical drive and draws its current from an assembly of fuel cells to be operated using methanol or hydrocarbons, the fuel is usually reacted with water vapor in a reformer at elevated temperature to give hydrogen and carbon dioxide, and the reaction gas is freed from carbon monoxide by-product, and the hydrogen-CO₂ mixture is passed into the anode space. The “proton exchange membrane fuel cell” is currently favored for this purpose, and has a water-saturated acidic ion-exchanger membrane between the porous, catalyst-containing electrodes. However, work is also taking place on the direct oxidation of methanol for mobile applications, and this would render a reformer superfluous.

The conduit systems for feeding fuel have hitherto usually been manufactured from stainless steel. However, conduits of this type are expensive. Accordingly, there remains a need for conduit systems which address these difficulties.

### SUMMARY OF THE INVENTION

It is an object of the present invention to provide conduits which overcome the difficulties described above.

It is another object of the present invention to provide lower-priced conduits which nevertheless have good barrier action with respect to hydrocarbons, alcohols, water, alcohol/water mixtures, and hydrogen. In one embodiment, it is preferred that in order to prevent poisoning of the catalyst or undesired polarization, there is very substantially no leaching of components which can react with the electrolyte or with the anode material from the material of the conduit system.

The objects of the invention may be achieved with an element of a conduit system of a fuel cell, where that part of the system which is in contact with the conveyed medium is composed of a polyester molding composition.

Accordingly, the present invention provides an element of a conduit system of a fuel cell, wherein a part which is to be in contact with the medium to be conveyed is composed of a polyester molding composition.

The present invention also provides a fuel cell system, which comprises a conduit system, wherein the conduit system comprises the element described above.

The present invention also provides a motor vehicle which comprises the fuel cell system described above.

The present invention also provides a method of making the fuel cell system described above, comprising incorporating the conduit system into a fuel cell.

The present invention also provides method of making the motor vehicle described above, comprising incorporating the fuel cell into a motor vehicle.

A more complete appreciation of the invention and many of the attendant advantages thereof will be readily obtained as the same becomes better understood by reference to the following detailed description.

### DETAILED DESCRIPTION OF THE INVENTION

Examples of elements of this type are a pipe or a pipe-like molding, which may be either a single-layer pipe or a multilayer pipe, in which the innermost layer is composed of the polyester molding composition. Such a pipe or pipe-like molding may be manufactured either in the form of a smooth pipe, subsequently thermoformed where appropriate, or in the form of a corrugated pipe. Other components which may be mentioned are those in which fluids are stored, for example storage vessels. Here, too, these components may either be composed solely of the polyester molding composition or be composed of a multilayer composite with an innermost layer made from the polyester molding composition. Examples of other elements are connectors, for example what are known as quick connectors, adapters, filters, components in pumps, and components in valves.

The elements of the invention may be manufactured with the aid of the usual plastics processing methods, for example by means of extrusion (e.g. monopipe), coextrusion (e.g. multilayer pipe), blow molding, or specialized forms thereof, such as suction blow molding or 3D parison manipulation, the parison being extruded in the case of single-layer elements and coextruded in the case of multilayer elements, or by means of injection molding or else specialized methods thereof, e.g. fluid injection technology, or by means of rotational sintering.

Thermoplastic polyesters are prepared by polycondensing diols with dicarboxylic acids or with their polyester-forming derivatives, such as dimethyl esters. Suitable diols may be those represented by the formula HO—R—OH, where R is a divalent, branched or unbranched aliphatic and/or cycloaliphatic radical having from 2 to 40 carbon atoms, preferably from 2 to 12 carbon atoms. These ranges for the number of carbon atoms include all specific values and subranges therebetween, such as 4, 6, 10, 12, 18, 22, and 30 carbon atoms. Suitable dicarboxylic acids have the formula HOOC—R′—COOH, where R′ is a divalent aromatic radical having from 6 to 20 carbon atoms, preferably from 6 to 12 carbon atoms. These ranges for the number of carbon atoms include all specific values and subranges therebetween, such as 8, 10, 14, 16, and 18 carbon atoms.

Examples of suitable diols include ethylene glycol, trimethylene glycol, tetramethylene glycol, but-2-ene-1,4-diol, hexamethylene glycol, neopentyl glycol, cyclohexanedimethanol, and also the C₃₆ diol dimerdiol. The diols may be used alone or as a mixture thereof.

Examples of aromatic dicarboxylic acids which may be used are terephthalic acid, isophthalic acid, naphthalene-1,4-, -1,5-, -2,6-, or -2,7-dicarboxylic acid, diphenic acid, and diphenyl ether 4,4′-dicarboxylic acid. Up to 30 mol % of these dicarboxylic acids, preferably up to 10 mol %, may have been replaced by aliphatic or cycloaliphatic dicarboxylic acids having from 3 to 50 carbon atoms, preferably having from 6 to 40 carbon atoms, e.g. succinic acid, adipic acid, sebacic acid, dodecanedioic acid, or cyclohexane-1,4-dicarboxylic acid. These ranges for the number of carbon atoms include all specific values and subranges therebetween, such as 4, 6, 10, 12, 18, 22, and 30 carbon atoms.

Examples of suitable polyesters are polyethylene terephthalate, polypropylene terephthalate, polybutylene terephthalate, polyethylene 2,6-naphthalate, polypropylene 2,6-naphthalate, polybutylene 2,6-naphthalate, poly(1,4-dimethylenecyclohexane terephthalate), and poly(1,4-dimethylenecyclohexane 2,6-naphthalate).

The preparation of these polyesters is well-known in the art (see DE-A 24 07 155, 24 07 156; Ullmanns Encyclopädie der technischen Chemie, [Ullman's Encyclopedia of Industrial Chemistry] 4th edn., Vol. 19, pp. 65 et seq., Verlag Chemie, Weinheim, Germany, 1980, all of which are incorporated herein by reference).

Although the reason for this may not be clear, particularly suitable polyesters have proven to be those which comprise not more than 300 ppm, preferably not more than 150 ppm, particularly preferably not more than 100 ppm, and very particularly preferably not more than 50 ppm, based in each case on the metal content, of a metal compound which catalyzes transesterification and/or esterification, or of products obtained from these.

The polyester molding composition may comprise up to 40% by weight of other thermoplastics, in particular impact-modifying rubbers. Thus, the composition comprises up to 0.01, 0.02, 0.05, 1, 2, 5, 10, 25, 30 and 35% by weight of such other thermoplastics. It may moreover comprise the auxiliaries and additives conventionally used for polyesters, e.g. processing aids, nucleating agents, intercalated or exfoliated phyllosilicates, crystallization accelerators, light and/or heat stabilizers, metal scavengers and/or complex formers, conductivity-increasing additives, such as carbon black, carbon fibers, steel fibers, nanotubes, etc., or reinforcing additives, such as glass fibers, or pigments.

The selection of these additives must be such that they cause no increase, or only a slight increase, in the conductivity of the medium which is conducted across the polyester molding composition. If the medium used is water, the conductivity at 90° C. should increase by not more than 100 μS/cm, preferably not more than 50 μS/cm, and particularly preferably not more than 30 μS/cm. If a mixture of water and methanol (60:40% by volume) is used, the conductivity at 90° C. should increase by not more than 80 μS/cm, preferably by not more than 40 μS/cm, and particularly preferably by not more than 20 μS/cm.

The polyester molding composition preferably has a continuous polyester phase, and it is preferable here for the entire matrix to be composed of polyester in which the other components have been dispersed.

In one preferred embodiment, the polyester molding composition has been provided with antistatic properties by means of the abovementioned conductivity-increasing additives, and therefore permits electrostatic charges arising during the transport of combustible media to be reliably dissipated. In this instance there is an insulating element separating the conduit system from the anode, as in the case of the stainless steel conduits used hitherto.

The conduit system of the invention or its separate elements may be manufactured at low cost. It moreover also has low weight, and this is specifically advantageous in mobile use.

The invention also provides the fuel-cell system which comprises the element of the invention, for example for driving a motor vehicle.

Obviously, numerous modifications and variations of the present invention are possible in light of the above teachings. It is therefore to be understood that within the scope of the appended claims, the invention may be practiced otherwise than as specifically described herein.

This application is based on German Patent Application Serial No. 10150258.3, filed on Oct. 11, 2001, and incorporated herein by reference in its entirety.

What is claimed is:

1. An element of a conduit system of a fuel cell, wherein a part which is to be in contact with the medium to be conveyed is composed of a polyester molding composition.

2. The element of a conduit system of a fuel cell as claimed in claim 1, wherein the element is a pipe, a multilayer pipe, a storage vessel, a connector, an adapter, a filter, a component of a pump, or a component of a valve.

3. The element of a conduit system of a fuel cell as claimed in claim 1, wherein the element is a pipe.

4. The element of a conduit system of a fuel cell as claimed in claim 1, wherein polyester is thermoplastic.

5. The element of a conduit system of a fuel cell as claimed in claim 1, wherein the polyester is the product of condensing at least one diol with at least one dicarboxylic acid or a polyester-forming derivative thereof.

6. The element of a conduit system of a fuel cell as claimed in claim 5, wherein the diol is represented by the formula HO—R—OH, wherein R is a divalent, branched or unbranched aliphatic and/or cycloaliphatic radical having from 2 to 40 carbon atoms.

7. The element of a conduit system of a fuel cell as claimed in claim 6, wherein R has 2 to 12 carbon atoms.

8. The element of a conduit system of a fuel cell as claimed in claim 6, wherein the diol comprises one or more members selected from the group consisting of ethylene glycol, trimethylene glycol, tetramethylene glycol, but-2-ene-1,4-diol, hexamethylene glycol, neopentyl glycol, cyclohexanedimethanol, and the C₃₆ diol dimerdiol.

9. The element of a conduit system of a fuel cell as claimed in claim 5, wherein the dicarboxylic acid is represented by the formula HOOC—R′—COOH, wherein R′ is a divalent aromatic radical having from 6 to 20 carbon atoms.

10. The element of a conduit system of a fuel cell as claimed in claim 5, wherein R′ has 6 to 12 carbon atoms.

11. The element of a conduit system of a fuel cell as claimed in claim 5, wherein the dicarboxylic acid comprises one or more members selected from the group consisting of terephthalic acid, isophthalic acid, naphthalene-1,4-, -1,5-, -2,6-, or -2,7-dicarboxylic acid, diphenic acid, and diphenyl ether 4,4′-dicarboxylic acid.

12. The element of a conduit system of a fuel cell as claimed in claim 5, wherein up to 30 mol % of the dicarboxylic acid comprises at least one aliphatic or cycloaliphatic dicarboxylic acid having from 3 to 50 carbon atoms.

13. The element of a conduit system of a fuel cell as claimed in claim 5, wherein up to 30 mol % of the dicarboxylic acid comprises at least one aliphatic or cycloaliphatic dicarboxylic acid having from 6 to 40 carbon atoms.

14. The element of a conduit system of a fuel cell as claimed in claim 13, wherein the aliphatic or cycloaliphatic dicarboxylic acid is succinic acid, adipic acid, sebacic acid, dodecanedioic acid, or cyclohexane-1,4-dicarboxylic acid.

15. The element of a conduit system of a fuel cell as claimed in claim 5, wherein up to 10 mol % of the dicarboxylic acid comprises at least one aliphatic or cycloaliphatic dicarboxylic acid having from 3 to 50 carbon atoms.

16. The element of a conduit system of a fuel cell as claimed in claim 15, wherein the dicarboxylic acid comprises one or more members selected from the group consisting of succinic acid, adipic acid, sebacic acid, dodecanedioic acid, and cyclohexane-1,4-dicarboxylic acid.

17. The element of a conduit system of a fuel cell as claimed in claim 1, wherein the polyester molding composition comprises a polyester selected from the group consisting of polyethylene terephthalate, polypropylene terephthalate, polybutylene terephthalate, polyethylene 2,6-naphthalate, polypropylene 2,6-naphthalate, polybutylene 2,6-naphthalate, poly(1,4-dimethylenecyclohexane terephthalate), and poly(1,4-dimethylenecyclohexane 2,6-naphthalate).

18. The element of a conduit system of a fuel cell as claimed in claim 1, wherein the polyester molding composition comprises up to 40% by weight of thermoplastics other than the polyester.

19. The element of a conduit system of a fuel cell as claimed in claim 1, wherein the polyester molding composition has antistatic properties.

20. A fuel cell system, which comprises a conduit system, wherein the conduit system comprises the element of claim 1.

21. The fuel cell system of claim 20, which comprises hydrogen as the fuel.

22. A motor vehicle which comprises the fuel cell system of claim 20.

23. In fuel cell system, wherein the improvement is that an element of a conduit system of the fuel cell which is to be in contact with the medium to be conveyed is composed of a polyester molding composition.

24. A method of making the fuel cell system of claim 20, comprising incorporating the conduit system into a fuel cell.

25. A method of making the motor vehicle of claim 22, comprising incorporating the fuel cell into a motor vehicle.
